(19) United States
(12) Patent Application Publication
(10) Pub. No.: US 2026/0107232 A1
(43) Pub. Date: Apr. 16, 2026

(54) UPLINK POWER CONTROL METHOD AND APPARATUS THEREFOR

(71) Applicant: BEIJING XIAOMI MOBILE SOFTWARE CO., LTD., Beijing (CN)

(72) Inventor: Yajun ZHU, Beijing (CN)

(21) Appl. No.: 19/114,614

(22) PCT Filed: Sep. 26, 2022
(86) PCT No.: PCT/CN2022/121430

§ 371 Date: Mar. 24, 2025

(51) Int. Cl. H04W 52/14; H04W 52/24

(52) U.S. Cl. CPC H04W 52/146; H04W 52/243

(57) ABSTRACT

A method for controlling an uplink power includes: receiving first configuration information sent by a network device; determining at least one uplink power control parameter set; selecting an uplink power control parameter set corresponding to a target transmission resource set from the at least one uplink power control parameter set; and performing uplink power adjustment on the target transmission resource set.

### CROSS-REFERENCE TO RELATED APPLICATION

The present application is a U.S. national phase of International Application No. PCT/CN2022/121430, filed with the State Intellectual Property Office of P. R. China on Sep. 26, 2022, the contents of which are incorporated herein by reference in their entireties for all purposes.

### TECHNICAL FIELD

The disclosure relates to the field of communication technology, and in particular to a method and an apparatus for controlling an uplink power.

### BACKGROUND

In time division duplex (TDD) systems, under traditional deployment schemes, a TDD configuration of neighboring cells maintains a consistent transmission direction to avoid significant cross-interference. In order to better accommodate transmission of services, a base station may dynamically adjust the TDD configuration. However, under the scheme of adjusting the TDD configuration dynamically, the problem of cross-interference between uplink and downlink transmissions between different cells may occur.

In related art, power control is normally used to increase channel capacity and reduce neighboring cell interference. However, there is currently a lack of uplink power control scheme applicable to a dynamic TDD scenario.

### SUMMARY

According to a first aspect, embodiments of the disclosure provide a method for controlling an uplink power. The method is performed by a terminal, including: receiving first configuration information sent by a network device; determining at least one uplink power control parameter set; selecting an uplink power control parameter set corresponding to a target transmission resource set from the at least one uplink power control parameter set; and performing uplink power adjustment on the target transmission resource set.

According to a second aspect, embodiments of the disclosure provide a method for controlling an uplink power. The method is performed by a network device, including: configuring first configuration information based on an interference degree of at least one resource set; and sending the first configuration information to a terminal; in which the first configuration information indicates the terminal to determine at least one uplink power control parameter set.

According to a third aspect of embodiments of the disclosure, a communication apparatus is provided, which includes a processor and a memory. The memory is stored with a computer program; and the processor executes the computer program stored in the memory, so that the communication apparatus performs the method according to the first aspect.

According to a fourth aspect of embodiments of the disclosure, a communication apparatus is provided, which includes a processor and a memory. The memory is stored with a computer program; and the processor executes the computer program stored in the memory, so that the communication apparatus performs the method according to the second aspect.

According to a fifth aspect of embodiments of the disclosure, a non-transitory computer-readable storage medium is provided, which is configured to store instructions used by the terminal. When the instructions are executed, the terminal is caused to perform the method according to the first aspect.

According to a sixth aspect of embodiments of the disclosure, a non-transitory computer-readable storage medium is provided, which is configured to store instructions used by the network device. When the instructions are executed, the network device is caused to perform the method according to the second aspect.

### BRIEF DESCRIPTION OF THE DRAWINGS

In order to clearly illustrate technical solutions of the embodiments and the background of the present disclosure, a brief description of drawings used in embodiments and the background is given below.

FIG. 1 is a schematic diagram illustrating an architecture of a communication system according to an embodiment of the disclosure.

FIG. 2 is a flowchart illustrating a method for controlling an uplink power according to an embodiment of the disclosure.

FIG. 3 is a flowchart illustrating a method for controlling an uplink power according to an embodiment of the disclosure.

FIG. 4 is a flowchart illustrating a method for controlling an uplink power according to an embodiment of the disclosure.

FIG. 5 is a flowchart illustrating a method for controlling an uplink power according to an embodiment of the disclosure.

FIG. 6 is a flowchart illustrating a method for controlling an uplink power according to an embodiment of the disclosure.

FIG. 7 is a flowchart illustrating a method for controlling an uplink power according to an embodiment of the disclosure.

FIG. 8 is a flowchart illustrating a method for controlling an uplink power according to an embodiment of the disclosure.

FIG. 9 is a block diagram illustrating a communication apparatus according to an embodiment of the disclosure.

FIG. 10 is a block diagram illustrating a communication apparatus according to an embodiment of the disclosure.

### DETAILED DESCRIPTION

Embodiments of the disclosure are described in detail below, and examples of the embodiments are illustrated in the accompanying drawings, in which the same or similar symbols from beginning to end indicate the same or similar elements or the same or similar components. The embodiments described below by reference to the accompanying drawings are exemplary and are intended to be used to explain the disclosure and are not to be construed as a limitation of the disclosure. In the description of the disclosure, unless otherwise indicated, the character “/” indicates an “or” relationship. For example, A/B may indicate either A or B. In the disclosure, the term “and/or” may describe association relationships of associated objects, indicating that there may be three types of relationships, for example, A and/or B, which may mean: A exists alone, A and B exist at the same time, and B exists alone.

Terms used in the embodiments of the disclosure are for the purpose of describing specific embodiments only, and are not intended to limit the embodiments of the disclosure. As used in the examples of this disclosure and the appended claims, the singular forms “a”, “said” and “the” are also intended to include the plural forms unless the context clearly dictates otherwise.

It should be understood that although the embodiments of the disclosure may use the terms first, second, third, etc. to describe various information, the information should not be limited to these terms. These terms are only used to distinguish information of the same type from one another. For example, without departing from the scope of the embodiments of the disclosure, first information may also be called second information, and similarly, second information may also be called first information. Depending on the context, the term “if” as used herein may be interpreted as “in a case that” or “when” or “in response to determining”.

Embodiments of the disclosure are described in detail below, examples of which are illustrated in the accompanying drawings. The same or similar reference numerals refer to the same or similar elements throughout the disclosure. The embodiments described below with reference to the accompanying drawings are exemplary and intended to explain the present disclosure and are not to be construed as limitations of the disclosure.

In order to better understand a method for controlling an uplink power in embodiments of the disclosure, a communication system to which embodiments of the disclosure are applicable is described below.

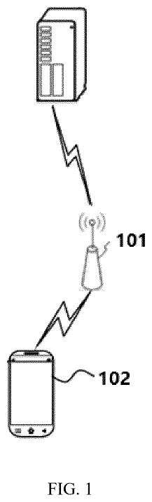

FIG. 1 is a schematic diagram illustrating an architecture of a communication system according to an embodiment of the disclosure. The communication system may include, but is not limited to, one network device and one terminal. A number and a form of the devices shown in FIG. 1 are only for example and do not constitute a limitation to embodiments of the disclosure, and the communication system may include two or more network devices and two or more terminals in practical applications. The communication system as illustrated in FIG. 1 includes one network device 101 and one terminal 102 for example.

It needs to be noted that technical solution in the embodiments of the disclosure may be applicable to various communication systems, for example, a long term evolution (LTE) system, a 5th generation (5G) mobile communication system, a 5G new radio (NR) system or other future new mobile communication systems.

The network device 101 in embodiments of the disclosure is an entity for transmitting or receiving a signal at a network side. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system. The embodiments of the present disclosure do not limit the specific technology and the specific device form used by the network device. The network device according to the embodiments of the disclosure may consist of a central unit (CU) and a distributed unit (DU). The CU may also be referred to as a control unit. The protocol layers of a network device such as a base station may be split by using a structure of the CU-DU, so that some functions of the protocol layer are centrally controlled by the CU, and some or all of remaining functions of the protocol layer are distributed in the DU, which is centrally controlled by the CU.

The terminal 102 in embodiments of the disclosure is an entity for receiving or transmitting a signal at a user side, for example, a mobile phone. The terminal may be referred to as a terminal, a user equipment (UE), a mobile station (MS), a mobile terminal (MT), etc. The terminal may be an automobile with a communication function, a smart automobile, a mobile phone, a wearable device, a tablet computer (Pad), a computer with a wireless transceiving function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, etc. The embodiments of the present disclosure do not limit the specific technology and the specific device form used by the terminal.

It should be understood that the communication system in the embodiments of the present disclosure is to more clearly illustrate the technical solution of the embodiments of the present disclosure, and does not constitute a limitation on the technical solution in the embodiments of the present disclosure. Those skilled in the art may know, with the evolution of the system architecture and the emergence of new service scenarios, the technical solution in the embodiments of the present disclosure is also applicable to similar technical problems.

A method and an apparatus for controlling an uplink power in the disclosure are further described in combination with the accompanying drawings.

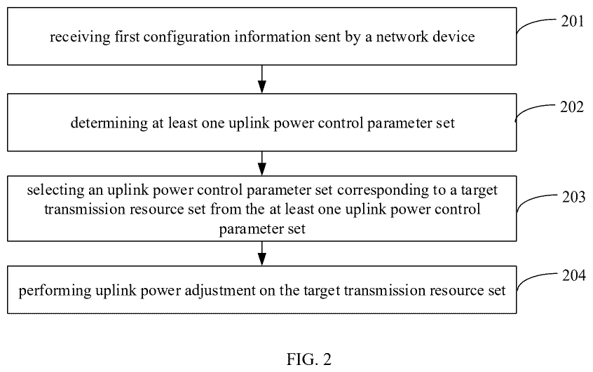

Referring to FIG. 2, FIG. 2 is a flowchart illustrating a method for controlling an uplink power according to an embodiment of the disclosure. It should be noted that the method for controlling an uplink power of the embodiment of the disclosure may be performed by a terminal. It should further be noted that the method for controlling an uplink power of the embodiment of the disclosure may be applied in a dynamic time division duplex (TDD) scenario. As shown in FIG. 2, the method may include, but is not limited to, the following steps 201 to 204.

At step 201, first configuration information sent by a network device is received.

It should be noted that in the dynamic TDD scenario, there is a problem of cross-interference between uplink and downlink transmissions between different cells. The cross-interference may be categorized into interference between network devices (e.g., base stations) and interference between terminals. Under different interference conditions, the network device may configure different first configuration information for the terminal. The first configuration information may indicate the terminal to determine at least one uplink power control parameter set.

For the interference between network devices (e.g., base stations), the network device in the disclosure is an interfered network device, and the terminal in the disclosure is an interfered terminal served by the network device. In an implementation, the first configuration information is configured by the interfered network device based on an interference degree of at least one resource set; and the interference degree of the at least one resource set is obtained by the interfered network device performing an interference measurement on a downlink signal of an interfering network device at a predetermined time-frequency position.

That is, for the interference between network devices (e.g., base stations), the interfered network device performs an interference measurement on a downlink signal of an interfering network device at a predetermined time-frequency position, to determine an interference degree of at least one resource set, and configures the first configuration information for the interfered terminal based on the interference degree of the at least one resource set.

For the interference between terminals, the network device in the disclosure is an interfering network device, and the terminal in the disclosure is an interfering terminal served by the network device. In an implementation, the first configuration information is configured by the interfering network device based on an interference degree of at least one resource set. The interference degree of the at least one resource set is obtained by an interfered terminal performing an interference measurement on an uplink signal of the interfering terminal at a predetermined time-frequency position, and the interference degree of the at least one resource set is sent by the interfered terminal to the interfering network device via a network device serving the interfered terminal. Alternatively, the interference degree of the at least one resource set is sent to the interfering network device by the interfered terminal; the interfered terminal is a terminal interfered by the interfering terminal.

Optionally, in the case that the network device is a base station, for the interference between terminals, the interfered terminal reports the interference degree of the at least one resource set to a serving base station. The serving base station forwards the interference degree of the at least one resource set to an interfering base station. Alternatively, for the interference between terminals, the interfered terminal directly reports the interference degree of the at least one resource set to the interfering base station. The interfering base station configures the first configuration information for the interfering terminal based on the interference degree of the at least one resource set.

At step 202, at least one uplink power control parameter set is determined.

In an embodiment of the disclosure, each uplink power control parameter set may include, but is not limited to, parameters such as a target received power and/or a power adjustment step size.

Optionally, after receiving the first configuration information sent by the network device, the terminal determines the at least one uplink power control parameter set. For example, the terminal may determine the at least one uplink power control parameter set based on the first configuration information.

In an implementation, the at least one uplink power control parameter set may be independently configured. That is, the at least one uplink power control parameter set may be independently configured based on different configuration parameters. For example, if there are two uplink power control parameter sets, such as a parameter set 1 and a parameter set 2, the parameter set 1 may be configured using a configuration parameter 1 and the parameter set 2 may be configured using a configuration parameter 2.

In another implementation, the first configuration information may include an uplink power control parameter reference set and an offset value. The terminal may determine the at least one uplink power control parameter set based on the uplink power control parameter reference set and the offset value in the first configuration information.

Optionally, the first configuration information may include one uplink power control parameter reference set and at least one offset value. The terminal may determine an uplink power control parameter in the at least one uplink power control parameter set based on an uplink power control parameter in the uplink power control parameter reference set and the at least one offset value. The number of offset values may be the same as the number of uplink power control parameter reference sets, or, the number of offset values may be smaller than the number of uplink power control parameter reference sets by one. For example, in the case that the uplink power control parameter reference set does not act as a parameter set in the at least one uplink power control parameter set, the number of offset values may be the same as the number of uplink power control parameter reference sets. In the case that the uplink power control parameter reference set acts as a parameter set in the at least one uplink power control parameter set, the number of offset values may be smaller than the number of uplink power control parameter reference sets by one.

For example, in the case that there are three uplink power control parameter sets, and the first configuration information includes one uplink power control parameter reference set (e.g., a reference parameter set 1) and two offset values (e.g., an offset value 1 and an offset value 2), the terminal may determine the reference parameter set 1 as a first uplink power control parameter set, determine a second uplink power control parameter set based on the reference parameter set 1 and the offset value 1, and determine a third uplink power control parameter set based on the reference parameter set 1 and the offset value 2.

For example, in the case that there are two uplink power control parameter sets, and the first configuration information includes one uplink power control parameter reference set (e.g., a reference parameter set 1) and two offset values (e.g., an offset value 1 and an offset value 2), the terminal may determine a first uplink power control parameter set based on the reference parameter set 1 and the offset value 1, and determine a second uplink power control parameter set based on the reference parameter set 1 and the offset value 2.

At step 203, an uplink power control parameter set corresponding to a target transmission resource set is selected from the at least one uplink power control parameter set.

In an embodiment of the disclosure, the target transmission resource set may include a transmission resource in a time domain or a frequency domain.

Optionally, the terminal may select the uplink power control parameter set corresponding to the target transmission resource set from the at least one uplink power control parameter set. That is, the terminal may determine the uplink power control parameter sets configured by the network device for the terminal from the first configuration information, and select the uplink power control parameter set corresponding to the target transmission resource set from the uplink power control parameter sets.

At step 204, uplink power adjustment is performed on the target transmission resource set.

In an implementation, the terminal may perform the uplink power adjustment on the target transmission resource set using the uplink power control parameter set corresponding to the target transmission resource set. In an embodiment of the disclosure, there are one or more target transmission resource sets.

In the implementation of the embodiment of the disclosure, by considering changes in different interference conditions on different transmission resources, different uplink power parameters may be used to perform uplink power adjustment under different interference conditions, which effectively avoids interference to neighboring cells, and effectively reduces power consumption of the terminal.

It should be noted that in the dynamic TDD scenario, there is a problem of cross-interference between uplink and downlink transmissions between different cells. The cross-interference may be categorized into interference between network devices (e.g., base stations) and interference between terminals. For the interference between network devices (e.g., base stations), the uplink power of the interfered terminal needs to be adjusted to effectively avoid interference to neighboring cells and effectively reduce the power consumption of the terminal. For the interference between terminals, the uplink power of the interfering terminal needs to be adjusted to effectively avoid interference to neighboring cells and effectively reduce the power consumption of the terminal. The disclosure will be described in detail in the following in terms of the interference between network devices (e.g., base stations) and the interference between terminals.

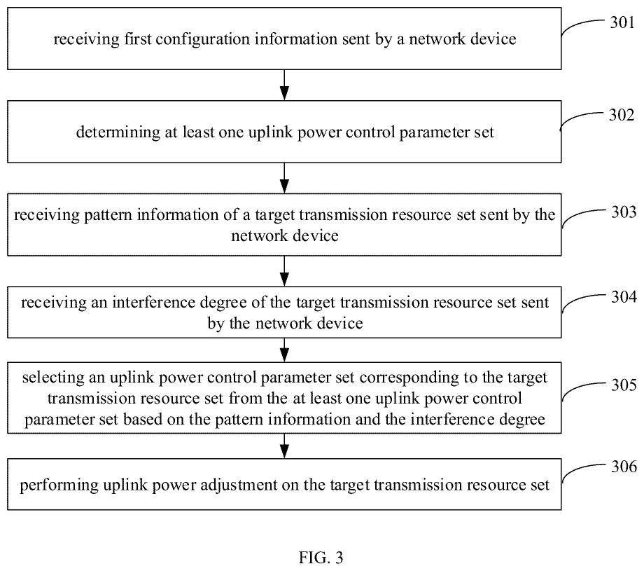

Referring to FIG. 3, FIG. 3 is a flowchart illustrating a method for controlling an uplink power according to an embodiment of the disclosure. It should be noted that the method may be performed by a terminal. It should further be noted that the method for controlling an uplink power of the embodiment of the disclosure may be applied in a dynamic TDD scenario. As shown in FIG. 3, the method may include, but is not limited to, the following steps 301 to 306.

At step 301, first configuration information sent by a network device is received.

In the embodiment of the disclosure, step 301 may be implemented using any method of the embodiments of the disclosure, which is not limited and not repeated in the embodiment of the disclosure.

At step 302, at least one uplink power control parameter set is determined.

In the embodiment of the disclosure, step 302 may be implemented using any method of the embodiments of the disclosure, which is not limited and not repeated in the embodiment of the disclosure.

At step 303, pattern information of a target transmission resource set sent by the network device is received.

Optionally, the terminal may receive the pattern information of the target transmission resource set sent by the network device. The terminal may learn which transmission resources are specifically configured by the network device for the terminal based on the pattern information.

At step 304, an interference degree of the target transmission resource set sent by the network device is received.

Optionally, the network device has different interference degrees on different transmission resource sets. The network device may send the interference degree on the target transmission resource set to the terminal. The terminal may receive the interference degree of the target transmission resource set sent by the network device.

At step 305, an uplink power control parameter set corresponding to the target transmission resource set is selected from the at least one uplink power control parameter set based on the pattern information and the interference degree.

In an implementation, the terminal may receive the pattern information of the target transmission resource set from the network device to determine a configuration parameter for performing an uplink transmission on the target transmission resource set. The terminal may select the uplink power control parameter set that should be used on the target transmission resource set based on the interference degree of the target transmission resource set.

At step 306, uplink power adjustment is performed on the target transmission resource set.

In the embodiment of the disclosure, step 306 may be implemented using any method of the embodiments of the disclosure, which is not limited and not repeated in the embodiment of the disclosure.

In the implementation of the embodiment of the disclosure, by receiving, by the terminal, the pattern information of the target transmission resource set and the interference degree of the target transmission resource set sent by the network device; selecting the uplink power control parameter set that should be used on the target transmission resource set, and performing uplink power adjustment on the target transmission resource set using the corresponding uplink power control parameter set, different uplink power parameters may be used to perform uplink power adjustment under different interference conditions, which effectively avoids interference to neighboring cells, and effectively reduces power consumption of the terminal.

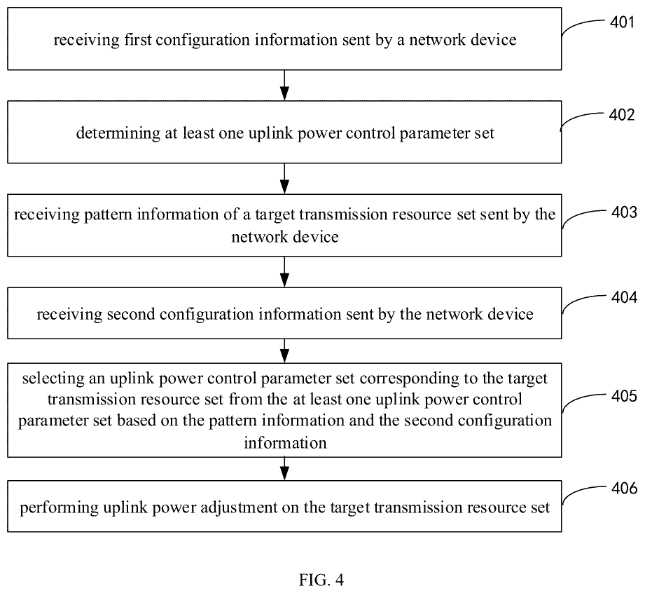

Referring to FIG. 4, FIG. 4 is a flowchart illustrating a method for controlling an uplink power according to an embodiment of the disclosure. It should be noted that the method may be performed by a terminal. It should further be noted that the method for controlling an uplink power of the embodiment of the disclosure may be applied in a dynamic TDD scenario. As shown in FIG. 4, the method may include, but is not limited to, the following steps 401 to 406.

At step 401, first configuration information sent by a network device is received.

In the embodiment of the disclosure, step 401 may be implemented using any method of the embodiments of the disclosure, which is not limited and not repeated in the embodiment of the disclosure.

At step 402, at least one uplink power control parameter set is determined.

In the embodiment of the disclosure, step 402 may be implemented using any method of the embodiments of the disclosure, which is not limited and not repeated in the embodiment of the disclosure.

At step 403, pattern information of a target transmission resource set sent by the network device is received.

Optionally, the terminal may receive the pattern information of the target transmission resource set sent by the network device. The terminal may learn which transmission resources are specifically configured by the network device for the terminal based on the pattern information.

At step 404, second configuration information sent by the network device is received.

In an embodiment of the disclosure, the second configuration information indicates an uplink power control parameter set corresponding to the target transmission resource set. That is, the second configuration information may indicate a mapping relationship between the target transmission resource set and the uplink power control parameter set.

In an implementation, there is a correspondence between the transmission resource sets and the uplink power control parameter sets. That is, each transmission resource set has a corresponding uplink power control parameter set. The terminal receives the pattern information of the target transmission resource set sent by the network device and receives the second configuration information of the uplink power control parameter set corresponding to each transmission resource set, so that the terminal determines a mapping relationship between the transmission resource sets and the uplink power control parameter sets.

At step 405, the uplink power control parameter set corresponding to the target transmission resource set is selected from the at least one uplink power control parameter set based on the pattern information and the second configuration information.

Optionally, the terminal may learn which target transmission resource set is specifically configured by the network device for the terminal based on the pattern information and learn the mapping relationship between the target transmission resource set and the uplink power control parameter set based on the second configuration information. Thus, the terminal may select the uplink power control parameter set corresponding to the target transmission resource set from the at least one uplink power control parameter set based on the pattern information and the second configuration information.

For example, assume that after receiving the first configuration information sent by the network device, the terminal determines that the network device configures an uplink power control parameter set 1, an uplink power control parameter set 2, and an uplink power control parameter set 3 for the terminal; after receiving the pattern information sent by the network device, the terminal learns that the network device specifically configures a target transmission resource set a and a target transmission resource set b for the terminal; after receiving the second configuration information sent by the network device, the terminal learns about the mapping relationship between the target transmission resource set and the uplink power control parameter set. For example, the second configuration information includes an indication field, in which the indication field indicates the mapping relationship between the target transmission resource set and the uplink power control parameter set. For example, if the indication field is 00, it indicates a mapping relationship between the target transmission resource set a and the uplink power control parameter set 1, i.e., the target transmission resource set a corresponds to the uplink power control parameter set 1. For example, if the indication field is 01, it indicates a mapping relationship between the target transmission resource set b and the uplink power control parameter set 2, i.e., the target transmission resource set b corresponds to the uplink power control parameter set 2. Thus, the terminal may select the uplink power control parameter set corresponding to the target transmission resource set from the uplink power control parameter set 1, the uplink power control parameter set 2, and the uplink power control parameter set 3 based on the pattern information and the second configuration information.

At step 406, uplink power adjustment is performed on the target transmission resource set.

In the embodiment of the disclosure, step 406 may be implemented using any method of the embodiments of the disclosure, which is not limited and not repeated in the embodiment of the disclosure.

In the implementation of the embodiment of the disclosure, by selecting, by the terminal, the uplink power control parameter set that should be used on the target transmission resource set based on the pattern information of the target transmission resource set and the second configuration information and performing uplink power adjustment on the target transmission resource set using the corresponding uplink power control parameter set, different uplink power parameters may be used to perform uplink power adjustment under different interference conditions, which effectively avoids interference to neighboring cells, and effectively reduces power consumption of the terminal.

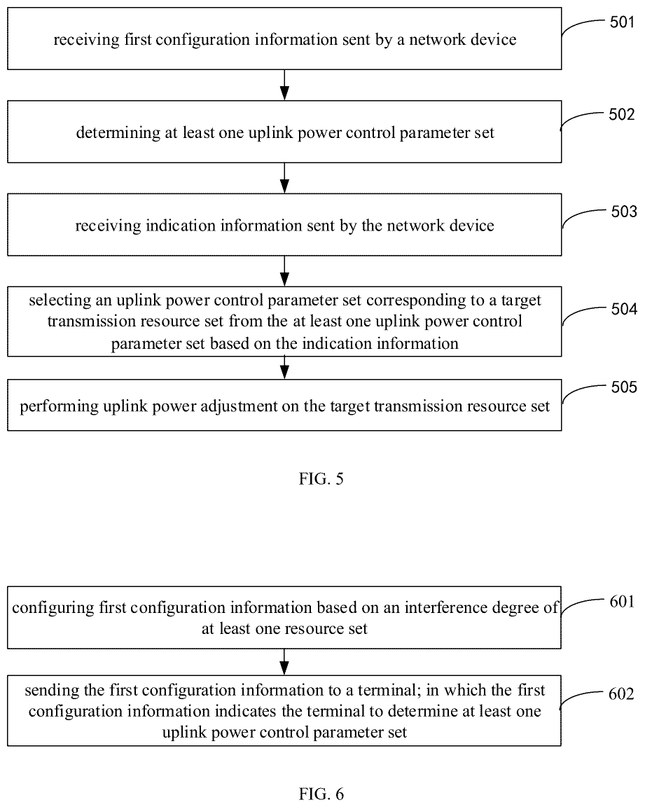

Referring to FIG. 5, FIG. 5 is a flowchart illustrating a method for controlling an uplink power according to an embodiment of the disclosure. It should be noted that the method may be performed by a terminal. It should further be noted that the method for controlling an uplink power of the embodiment of the disclosure may be applied in a dynamic TDD scenario. As shown in FIG. 5, the method may include, but is not limited to, the following steps 501 to 505.

At step 501, first configuration information sent by a network device is received.

In the embodiment of the disclosure, step 501 may be implemented using any method of the embodiments of the disclosure, which is not limited and not repeated in the embodiment of the disclosure.

At step 502, at least one uplink power control parameter set is determined.

In the embodiment of the disclosure, step 502 may be implemented using any method of the embodiments of the disclosure, which is not limited and not repeated in the embodiment of the disclosure.

At step 503, indication information sent by the network device is received.

In an embodiment of the disclosure, the indication information indicates an uplink power control parameter set corresponding to a target transmission resource set.

In an implementation, the indication information that indicates the uplink power control parameter set may be carried in downlink control information (DCI). The indication information may be carried either explicitly or implicitly.

At step 504, the uplink power control parameter set corresponding to the target transmission resource set is selected from at least one uplink power control parameter set based on the indication information.

Optionally, the target transmission resource set may further be indicated in the indication information.

In an implementation, in an explicit manner, an uplink power control parameter set on the target transmission resource set may be indicated in a target information field in the DCI. Optionally, a correspondence between the target information field and the uplink power control parameter set needs to be configured in advance. For example, the correspondence may be shown in the following table.

TABLE 1
correspondence between the target information field
in DCI and the uplink power control parameter set

| indication | parameter set |
|---|---|
| information | indication |
| 00 | parameter set1 |
| 01 | parameter set2 |
| 10 | parameter set3 |
| 11 | parameter set4 |

For example, in table 1, the indication information 01 of the target information field in the DCI corresponds to a parameter set 2 in the uplink power control parameter set. The indication information 11 of the target information field in the DCI corresponds to a parameter set 4 in the uplink power control parameter set.

It may be understood that each element in Table 1 exists independently. These elements are listed in the same table for illustrative purposes, but this does not mean that all elements in the table must exist simultaneously as shown in the table. The value of each of these elements is independent of the value of any other element in Table 1. Thus, those skilled in the art may understand that the value of each element in Table 1 is an independent embodiment. It should be noted that embodiments of the disclosure include a plurality of tables, and each table is similar to Table 1, where a plurality of independent embodiments are merged in the same table. Each element in these tables should be considered as an independent embodiment.

In an implementation, in an implicit manner, the uplink power control parameter set indicated by scheduling may be carried implicitly via a radio network temporary identifier (RNTI) or a scrambling sequence. For example, in the case of using the RNTI, the terminal may determine the uplink power control parameter set corresponding to the target transmission resource set based on an RNTI value scrambled on the DCI by defining a correspondence between the RNTI and the uplink power control parameter set. Alternatively, orthogonal scrambling sequences may be defined, in which different scrambling sequences correspond to different uplink power control parameter sets. The scrambling sequence is scrambled on the target indication information. The terminal determines the uplink power control parameter set corresponding to the target transmission resource set based on the detected scrambling sequence.

At step 505, uplink power adjustment is performed on the target transmission resource set.

In the embodiment of the disclosure, step 505 may be implemented using any method of the embodiments of the disclosure, which is not limited and not repeated in the embodiment of the disclosure.

In the implementation of the embodiment of the disclosure, by receiving, by the terminal, a signaling indication of the network device, selecting the uplink power control parameter set that should be used on the target transmission resource set, and performing uplink power adjustment on the target transmission resource set using the corresponding uplink power control parameter set, different uplink power parameters may be used to perform uplink power adjustment under different interference conditions, which effectively avoids interference to neighboring cells, and effectively reduces power consumption of the terminal.

It may be understood that the above embodiments describe the implementation of the method for controlling an uplink power of the embodiments of the disclosure from a terminal side. Embodiments of the disclosure further provide a method for controlling an uplink power, and the following describes the implementation of the method for controlling an uplink power from a network device side. FIG. 6 is a flowchart illustrating a method for controlling an uplink power according to an embodiment of the disclosure. It should be noted that the method for controlling an uplink power in the embodiment of the disclosure may be performed by a network device. As shown in FIG. 6, the method may include, but is not limited to, the following steps 601 to 602.

At step 601, first configuration information is configured based on an interference degree of at least one resource set.

It should be noted that in a dynamic TDD scenario, there is a problem of cross-interference between uplink and downlink transmissions between different cells. The cross-interference may be categorized into interference between network devices (e.g., base stations) and interference between terminals. In different interference conditions, the network device may configure different first configuration information for the terminal. The first configuration information may indicate the terminal to determine at least one uplink power control parameter set.

For the interference between network devices (e.g., base stations), the network device in the disclosure is an interfered network device, and the terminal in the disclosure is an interfered terminal served by the network device. In an implementation, the first configuration information is configured by the interfered network device based on an interference degree of at least one resource set; and the interference degree of the at least one resource set is obtained by the interfered network device performing an interference measurement on a downlink signal of an interfering network device at a predetermined time-frequency position.

For the interference between terminals, the network device in the disclosure is an interfering network device, and the terminal in the disclosure is an interfering terminal served by the network device. In an implementation, the first configuration information is configured by the interfering network device based on an interference degree of at least one resource set. The interference degree of the at least one resource set is obtained by an interfered terminal performing an interference measurement on an uplink signal of the interfering terminal at a predetermined time-frequency position, and the interference degree of the at least one resource set is sent by the interfered terminal to the interfering network device via a network device serving the interfered terminal. Alternatively, the interference degree of the at least one resource set is sent to the interfering network device by the interfered terminal; the interfered terminal is a terminal interfered by the interfering terminal.

At step 602, the first configuration information is sent to a terminal, in which the first configuration information indicates the terminal to determine at least one uplink power control parameter set.

In an embodiment of the disclosure, each uplink power control parameter set may include, but is not limited to, parameters such as a target received power and/or a power adjustment step size.

In some embodiments of the disclosure, the network device may further send pattern information of a target transmission resource set to the terminal; and send an interference degree of the target transmission resource set to the terminal, in which the pattern information and the interference degree are used for the terminal to select an uplink power control parameter set corresponding to the target transmission resource set from the at least one uplink power control parameter set.

In some embodiments of the disclosure, the network device may further send pattern information of a target transmission resource set to the terminal, and send second configuration information to the terminal; in which the second configuration information indicates the terminal to select an uplink power control parameter set corresponding to the target transmission resource set from the at least one uplink power control parameter set based on the pattern information and the second configuration information.

In some embodiments of the disclosure, the network device may further send indication information to the terminal, in which the indication information indicates the terminal to select an uplink power control parameter set corresponding to a target transmission resource set from the at least one uplink power control parameter set.

Optionally, an implementation of the terminal after receiving the first configuration information sent by the network device may be referred to the implementation of the method for controlling an uplink power described above on the terminal side, and further details will not be repeated.

In the implementation of the embodiment of the disclosure, by configuring a corresponding uplink power control parameter set by the network device for changes in different interference conditions on different transmission resources, the terminal may perform uplink power adjustment under different interference conditions using different uplink power parameters, which effectively avoids interference to neighboring cells, and effectively reduces power consumption of the terminal.

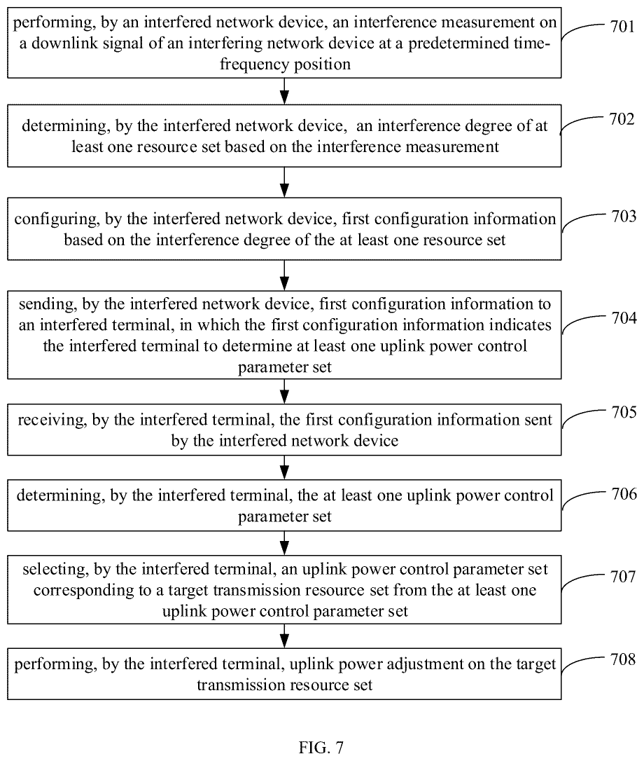

FIG. 7 is a flowchart illustrating a method for controlling an uplink power according to an embodiment of the disclosure. It should be noted that the method for controlling an uplink power in the embodiment of the disclosure may be used to solve the problem of interference between network devices (e.g., a base station). It should further be noted that the method for controlling an uplink power of the embodiment of the disclosure may be applied in a dynamic TDD scenario. As shown in FIG. 7, the method may include, but is not limited to, the following steps 701 to 708.

At step 701, an interfered network device performs an interference measurement on a downlink signal of an interfering network device at a predetermined time-frequency position.

At step 702, the interfered network device determines an interference degree of at least one resource set based on the interference measurement.

At step 703, the interfered network device configures first configuration information based on the interference degree of the at least one resource set.

At step 704, the interfered network device sends the first configuration information an interfered a terminal, in which the first configuration information indicates the interfered terminal to determine at least one uplink power control parameter set.

At step 705, the interfered terminal receives the first configuration information sent by the interfered network device.

At step 706, the interfered terminal determines the at least one uplink power control parameter set.

At step 707, the interfered terminal selects an uplink power control parameter set corresponding to a target transmission resource set from the at least one uplink power control parameter set.

At step 708, the interfered terminal performs uplink power adjustment on the target transmission resource set.

In the implementation of the embodiment of the disclosure, by performing the uplink power adjustment under different interference conditions using different uplink power parameters, the problem of interference between network devices (e.g., a base station) is solved, thus effectively avoiding interference to neighboring cells, and effectively reducing power consumption of the terminal.

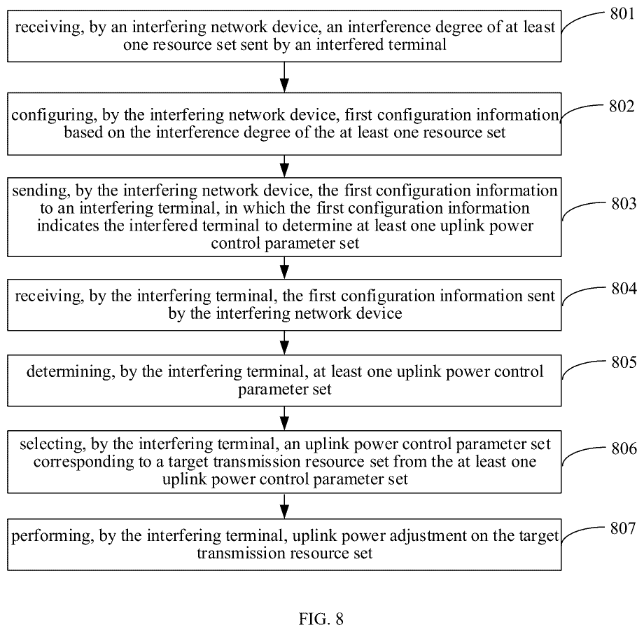

FIG. 8 is a flowchart illustrating a method for controlling an uplink power according to an embodiment of the disclosure. It should be noted that the method for controlling an uplink power in the embodiment of the disclosure may be used to solve the problem of interference between terminals. It should further be noted that the method for controlling an uplink power of the embodiment of the disclosure may be applied in a dynamic TDD scenario. As shown in FIG. 8, the method may include, but is not limited to, the following steps 801 to 807.

At step 801, an interfering network device receives an interference degree of at least one resource set measured by an interfered terminal.

In an embodiment of the disclosure, the interfered terminal is a terminal interfered by an interfering terminal.

In an embodiment of the disclosure, the interference degree of the at least one resource set is obtained by the interfered terminal performing an interference measurement on an uplink signal of the interfering terminal at a predetermined time-frequency position.

In an implementation, the interfering network device receives the interference degree of the at least one resource set sent by the interfered terminal, in which the interfered terminal is a terminal interfered by the interfering terminal.

In another implementation, the interfering network device receives the interference degree of the at least one resource set sent by a network device serving the interfered terminal.

At step 802, the interfering network device configures first configuration information based on the interference degree of the at least one resource set.

At step 803, the interfering network device sends the first configuration information to the interfering terminal, in which the first configuration information indicates the interfering terminal to determine at least one uplink power control parameter set.

At step 804, the interfering terminal receives the first configuration information sent by the interfering network device.

At step 805, the interfering terminal determines the at least one uplink power control parameter set.

At step 806, the interfering terminal selects an uplink power control parameter set corresponding to a target transmission resource set from the at least one uplink power control parameter set.

At step 807, the interfering terminal performs uplink power adjustment on the target transmission resource set.

In the implementation of the embodiment of the disclosure, by performing the uplink power adjustment under different interference conditions using different uplink power parameters, the problem of interference between terminals is solved, thus effectively avoiding interference to neighboring cells, and effectively reducing power consumption of the terminal.

In the above examples of embodiments provided in the disclosure, the methods in the embodiments of the disclosure are described from the perspectives of the terminal, and the network device, respectively. In order to realize each of the functions in the method provided in the above examples of embodiments of the disclosure, the network device and the terminal may include a hardware structure, a software module, so that each of the above examples of embodiments functions is implemented in the form of a hardware structure, a software module, or a hardware structure plus a software module. A function of each of the above examples of embodiment's functions may be performed in the form of the hardware structure, the software module, or the hardware structure plus the software module.

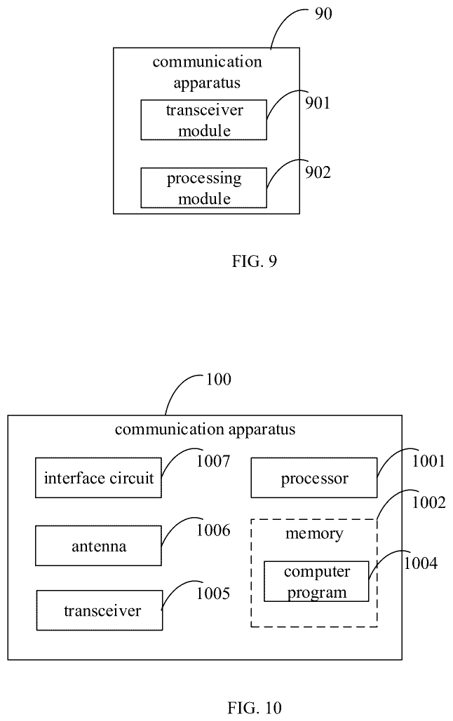

Referring to FIG. 9, it is a block diagram illustrating a communication apparatus 90 according to an embodiment of the disclosure. The communication apparatus 90 shown in FIG. 9 may include a transceiver module 901 and a processing module 902. The transceiver module 901 may include a transmitting module and/or a receiving module, the transmitting module for realizing a transmitting function, and the receiving module for realizing a receiving function, and the transceiver module 901 may realize the transmitting function and/or the receiving function.

The communication apparatus 90 may be a terminal, an apparatus in the terminal, or an apparatus capable of being used in combination with the terminal. Alternatively, the communication apparatus 90 may be a network device, an apparatus in the network device, or an apparatus capable of being used in combination with the network device.

The communication apparatus 900 is the terminal. The transceiver module 901 is configured to receive first configuration information sent by a network device. The processing module 902 is configured to determine at least one uplink power control parameter set. The processing module 902 is further configured to select an uplink power control parameter set corresponding to a target transmission resource set from the at least one uplink power control parameter set. The processing module 902 is further configured to perform uplink power adjustment on the target transmission resource set.

In an implementation, there are one or more target transmission resource sets.

In an implementation, the first configuration information includes an uplink power control parameter reference set and an offset value. The processing module 902 is specifically configured to: determine the at least one uplink power control parameter set based on the uplink power control parameter reference set and the offset value in the first configuration information.

In a possible implementation, the processing module 902 is specifically configured to: receive pattern information of the target transmission resource set sent by the network device; receive an interference degree of the target transmission resource set sent by the network device; and select the uplink power control parameter set corresponding to the target transmission resource set from the at least one uplink power control parameter set based on the pattern information and the interference degree.

In another possible implementation, the processing module 902 is specifically configured to: receive pattern information of the target transmission resource set sent by the network device; receive second configuration information sent by the network device, in which the second configuration information indicates the uplink power control parameter set corresponding to the target transmission resource set; and select the uplink power control parameter set corresponding to the target transmission resource set from the at least one uplink power control parameter set based on the pattern information and the second configuration information.

In another possible implementation, the processing module 902 is specifically configured to: receive indication information sent by the network device, in which the indication information indicates the uplink power control parameter set corresponding to the target transmission resource set; and select the uplink power control parameter set corresponding to the target transmission resource set from the at least one uplink power control parameter set based on the indication information.

In an implementation, the network device is an interfered network device, the terminal is an interfered terminal served by the network device; the first configuration information is configured by the interfered network device based on an interference degree of at least one resource set; and the interference degree of the at least one resource set is obtained by the interfered network device performing an interference measurement on a downlink signal of an interfering network device at a predetermined time-frequency position.

In another possible implementation, the network device is an interfering network device, and the terminal is an interfering terminal served by the network device; the first configuration information is configured by the interfering network device based on an interference degree of at least one resource set; the interference degree of the at least one resource set is obtained by an interfered terminal performing an interference measurement on an uplink signal of the interfering terminal at a predetermined time-frequency position, and the interference degree of the at least one resource set is sent by the interfered terminal to the interfering network device via a network device serving the interfered terminal; or the interference degree of the at least one resource set is sent to the interfering network device by the interfered terminal; the interfered terminal is a terminal interfered by the interfering terminal.

The communication apparatus 900 is the network device. The processing module 902 is configured to configure first configuration information based on an interference degree of at least one resource set. The transceiver module 901 is configured to send the first configuration information to a terminal, in which the first configuration information indicates the terminal to determine at least one uplink power control parameter set.

In an implementation, the first configuration information includes an uplink power control parameter reference set and an offset value.

In an implementation, the transceiver module 901 is further configured to: send pattern information of a target transmission resource set to the terminal; and send an interference degree of the target transmission resource set to the terminal, in which the pattern information and the interference degree are used for the terminal to select an uplink power control parameter set corresponding to the target transmission resource set from at least one uplink power control parameter set.

In an implementation, the transceiver module 901 is further configured to: send pattern information of a target transmission resource set to the terminal; and send second configuration information to the terminal, in which the second configuration information indicates the terminal to select an uplink power control parameter set corresponding to the target transmission resource set from the at least one uplink power control parameter set based on the pattern information and the second configuration information.

In an implementation, the transceiver module 901 is further configured to: send indication information to the terminal, in which the indication information indicates the terminal to select an uplink power control parameter set corresponding to the target transmission resource set from the at least one uplink power control parameter set.

In a possible implementation, the network device is an interfered network device, the terminal is an interfered terminal served by the network device. The processing module 902 is further configured to: perform an interference measurement on a downlink signal of an interfering network device at a predetermined time-frequency position; and determine the interference degree of the at least one resource set based on the interference measurement.

In a possible implementation, the network device is an interfering network device, and the terminal is an interfering terminal served by the network device. The transceiver module 901 is further configured to: receive the interference degree of the at least one resource set sent by an interfered terminal, in which the interfered terminal is a terminal interfered by the interfering terminal; or receive the interference degree of the at least one resource set sent by a network device serving the interfered terminal, in which the interference degree of the at least one resource set is obtained by the interfered terminal performing an interference measurement on an uplink signal of the interfering terminal at a predetermined time-frequency position.

For the communication apparatus in the above embodiments, the specific manner in which each module performs an operation has been described in detail in the embodiments relating to the method, which will not be described in detail herein.

FIG. 10 is a block diagram illustrating a communication apparatus 100 according to an embodiment of the disclosure. The communication apparatus 100 may be a network device, a terminal, a chip, a system on chip or a processor that supports the network device to implement the method, or a chip, a system on chip or a processor that supports the terminal to implement the method. The apparatus may be configured to implement the method described in the method embodiments, and reference may be made to descriptions in the method embodiments.

The communication apparatus 100 may include one or more processors 1001. The processor 1001 may include a general purpose processor or a dedicated processor. For example, the processor 1001 may be a baseband processor or a central processor. The baseband processor may be configured to process a communication protocol and communication data, and the central processor may be configured to control a communication apparatus (e.g., a base station, a baseband chip, a terminal, a terminal chip, a DU or CU, etc.), to execute a computer program, and process data of the computer program.

Alternately, the communication apparatus 100 may further include one or more memories 1002 with a computer program 1004 stored thereon. The memory 1002 executes the computer program 1004 so that the communication device 100 performs the method as described in the above method embodiments. Alternately, the memory 1002 may further store data. The communication apparatus 100 and the memory 1002 may be independently configured or integrated together.

Alternately, the communication apparatus 100 may further include a transceiver 1005 and an antenna 1006. The transceiver 1005 may be referred to as a transceiving unit, a transceiver or a transceiving circuit, which may be configured to achieve a transceiving function. The transceiver 1005 may include a receiver and a transmitter. The receiver may be referred to as a receiver or a receiving circuit, etc., for implementing a receiving function; the transmitter may be referred to as a transmitter or a transmitting circuit, etc. for implementing a transmitting function.

Alternately, the communication apparatus 100 may further include one or more interface circuits 1007. The interface circuit 1007 is configured to receive code instructions and transmit the code instructions to the processor 1001. The processor 1001 runs the code instructions so that the communication apparatus 100 performs the method according to the above method embodiment.

The communication apparatus 100 is a terminal. The processor 1001 is configured to execute step S202, step S203, and step S204 in FIG. 2; step S302, step S305, and step S306 in FIG. 3; step S402, step S405, and step S406 in FIG. 4; step S502, step S504, and step S505 in FIG. 5; step S706, step S707, and step S708 in FIG. 7; or step S805, step S806, and step S807 in FIG. 8. The transceiver 1005 is configured to execute step S201 in FIG. 2; step S301, step S303, and step S304 in FIG. 3; step S401, step S403, and step S404 in FIG. 4; step S501 and step S503 in FIG. 5; step S705 in FIG. 7; step S804 in FIG. 8.

The communication apparatus 100 is a network device. The transceiver 1005 is configured to execute step S602 in FIG. 6; step S704 in FIG. 7; or step S803 in FIG. 8. The processor 1001 is configured to execute step S601 in FIG. 6; step S701, step S702, and step S703 in FIG. 7; or step S801 and step S802 in FIG. 8.

In an implementation, the processor 1001 may include a transceiver configured to implement receiving and transmitting functions. For example, the transceiver may be a transceiving circuit, or an interface, or an interface circuit. The transceiving circuit, the interface or the interface circuit configured to implement receiving and transmitting functions may be separate or integrated together. The transceiving circuit, the interface or the interface circuit may be configured to read and write codes/data, or the transceiving circuit, the interface or the interface circuit may be configured to transmit or deliver a signal.

In an implementation, the processor 1001 may be stored with a computer program. The computer program runs on the processor 1001 so that the communication apparatus 100 performs the method as described in the above method embodiments. The computer program may be solidified in the processor 1001, in which case the processor 1001 may be implemented by a hardware.

In an implementation, the communication apparatus 100 may include a circuit that may implement a transmitting or receiving or communication function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe) and gallium arsenide (GaAs).

The communication apparatus described in the above embodiments may be a network device or a terminal, but the scope of the communication apparatus described in the disclosure is not limited thereto, and a structure of the communication apparatus may not be subject to FIG. 10. The communication apparatus may be a stand-alone device or may be a part of a larger device. For example, the communication apparatus may be the following.
(1) a stand-alone integrated circuit (IC), or a chip, or a system on chip or a subsystem;
(2) a set of one or more ICs, optionally, which may also include a storage component for storing data and a computer program;
(3) an ASIC, such as a Modem;
(4) a module that may be embedded within other devices;
(5) a receiver, a terminal, a smart terminal, a cellular phone, a wireless device, a handset, a mobile unit, a vehicle device, a network device, a cloud device, an artificial intelligence device, etc.;
(6) others, and so forth.

Those skilled in the related art may understand that, various illustrative logical blocks and steps listed in embodiments of the disclosure, may be implemented by an electronic hardware, a computer software or a combination of an electronic hardware and a computer software. Whether the function is implemented by the hardware or the software depends on specific applications and design requirements for an overall system. Those skilled in the art may implement the functions by using various methods for each specific application, but such an implementation should not be understood as beyond the protection scope of embodiments of the disclosure.

A system for controlling an uplink power is further provided in embodiments of the disclosure. The system includes a communication apparatus as a terminal and a communication apparatus as a network device in the preceding embodiment as shown in FIG. 9, or, the system includes a communication apparatus as a terminal and a communication apparatus as a network device in the preceding embodiment as shown FIG. 10.

A readable storage medium with instructions stored thereon is further provided in the disclosure. When the instructions are executed by a computer, steps in the any one method embodiment are implemented.

A computer program product is further provided in the disclosure. The computer program product implements functions of the above any one method embodiment when executed by a processor.

In the above embodiments, the functions may be wholly or partially implemented by a software, a hardware, a firmware, or any combination thereof. When implemented by a software, the functions may be implemented in whole or in part in the form of a computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another via wire (such as a coaxial cable, a fiber optic, a digital subscriber line (DSL)) or wireless (such as infrared, wireless, microwave). The computer-readable storage medium may be any available medium that may be accessed by a computer or a data storage device such as a server that integrates one or more of the available media, and a data center. The readable medium may be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in disclosure are distinguished merely for convenience of description, and are not intended to limit the scope of embodiments of the disclosure, but also to indicate an order of precedence.

At least one in the disclosure may also be described as one or more, and a plurality of may be two, three, four or more, which is not limited in the disclosure. In embodiments of the disclosure, for a kind of technical feature, technical features in the kind of technical feature are distinguished by “first”, “second”, “third”, “A”, “B”, “C” and “D”, and there is no order of precedence or magnitude between technical features described in “first”, “second”, “third”, “A”, “B”, “C” and “D”.

Corresponding relationships indicated by tables in the disclosure may be configured or predefined. Values of information in tables are only examples, and may be configured as other values, which are not limited in the disclosure. When corresponding relationships between information and parameters are configured, it is not always necessary to configure all corresponding relationships indicated in tables. For example, in the tables in the disclosure, corresponding relationships indicated by some rows may not be configured. For another example, appropriate transformations and adjustments, such as splitting and merging, may be made based on the above tables. Names of parameters shown in headers in the tables may be other names understandable by the communication apparatus, and values or representations of the parameters may be other values or representations understandable by the communication apparatus. When the above tables are implemented, other data structures may be used, and for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the disclosure, may be implemented by an electronic hardware or a combination of an electronic hardware and a computer software. Whether the functions are executed by the hardware or the software depends on a specific application and a design constraint of the technical solution. Those skilled in the art may adopt different methods for each specific application to implement the described functions, but such implementation should not be considered beyond the scope of the disclosure.

Those skilled in the art may clearly understand that, a specific working process of a system, an apparatus and a unit described above may refer to a corresponding process in the above method embodiments, which will not be repeated here.

It should also be noted that any process or method description depicted in the flow chart or otherwise described herein may be understood to represent a module, fragment, or portion of code including one or more executable instructions configured to implement the steps of a customized logic function or process. The scope of the preferred embodiments of this disclosure includes alternative implementations where the functions may be executed in a different order than shown or discussed. This may include executing functions simultaneously or in the reverse order based on the specific functionality involved. This should be understood by those skilled in the art related to the technical field of the disclosed embodiments.

The above are only implementations of the disclosure. However, the protection scope of the disclosure is not limited here. Changes and substitutions that may be easily considered by those skilled in the art shall be contained within the protection scope of the disclosure. Therefore, the protection scope of the disclosure shall be subject to the protection scope of claims.

1. A method for controlling an uplink power, performed by a terminal, comprising:
receiving first configuration information sent by a network device;
determining at least one uplink power control parameter set;
selecting an uplink power control parameter set corresponding to a target transmission resource set from the at least one uplink power control parameter set; and
performing uplink power adjustment on the target transmission resource set.

2. The method according to claim 1, wherein there are one or more target transmission resource sets.

3. The method according to claim 1, wherein the first configuration information comprises an uplink power control parameter reference set and an offset value; and determining the at least one uplink power control parameter set comprises:
determining the at least one uplink power control parameter set based on the uplink power control parameter reference set and the offset value in the first configuration information.

4. The method according to claim 1, wherein selecting the uplink power control parameter set corresponding to the target transmission resource set from the at least one uplink power control parameter set comprises:
receiving pattern information of the target transmission resource set sent by the network device;
receiving an interference degree of the target transmission resource set sent by the network device; and
selecting the uplink power control parameter set corresponding to the target transmission resource set from the at least one uplink power control parameter set based on the pattern information and the interference degree.

5. The method according to claim 1, wherein selecting the uplink power control parameter set corresponding to the target transmission resource set from the at least one uplink power control parameter set comprises:
receiving pattern information of the target transmission resource set sent by the network device;
receiving second configuration information sent by the network device, wherein the second configuration information indicates the uplink power control parameter set corresponding to the target transmission resource set; and
selecting the uplink power control parameter set corresponding to the target transmission resource set from the at least one uplink power control parameter set based on the pattern information and the second configuration information.

6. The method according to claim 1, wherein selecting the uplink power control parameter set corresponding to the target transmission resource set from the at least one uplink power control parameter set comprises:
receiving indication information sent by the network device, wherein the indication information indicates the uplink power control parameter set corresponding to the target transmission resource set; and
selecting the uplink power control parameter set corresponding to the target transmission resource set from the at least one uplink power control parameter set based on the indication information.

7. The method according to claim 1, wherein the network device is an interfered network device, the terminal is an interfered terminal served by the network device; the first configuration information is configured by the interfered network device based on an interference degree of at least one resource set; and the interference degree of the at least one resource set is obtained by the interfered network device performing an interference measurement on a downlink signal of an interfering network device at a predetermined time-frequency position.

8. The method according to claim 1, wherein the network device is an interfering network device, and the terminal is an interfering terminal served by the network device;
the first configuration information is configured by the interfering network device based on an interference degree of at least one resource set;
the interference degree of the at least one resource set is obtained by an interfered terminal performing an interference measurement on an uplink signal of the interfering terminal at a predetermined time-frequency position, and the interference degree of the at least one resource set is sent by the interfered terminal to the interfering network device via a network device serving the interfered terminal; or
the interference degree of the at least one resource set is sent to the interfering network device by the interfered terminal; the interfered terminal is a terminal interfered by the interfering terminal.

9. A method for controlling an uplink power, performed by a network device, comprising:
configuring first configuration information based on an interference degree of at least one resource set; and
sending the first configuration information to a terminal, wherein the first configuration information indicates the terminal to determine at least one uplink power control parameter set.

10. The method according to claim 9, wherein the first configuration information comprises an uplink power control parameter reference set and an offset value.

11. The method according to claim 9, further comprising:
sending pattern information of a target transmission resource set to the terminal; and
sending an interference degree of the target transmission resource set to the terminal, wherein the pattern information and the interference degree are used for the terminal to select an uplink power control parameter set corresponding to the target transmission resource set from the at least one uplink power control parameter set.

12. The method according to claim 9, further comprising:
sending pattern information of a target transmission resource set to the terminal; and
sending second configuration information to the terminal, wherein the second configuration information indicates the terminal to select an uplink power control parameter set corresponding to the target transmission resource set from the at least one uplink power control parameter set based on the pattern information and the second configuration information.

13. The method according to claim 9, further comprising:
sending indication information to the terminal, wherein the indication information indicates the terminal to select an uplink power control parameter set corresponding to a target transmission resource set from the at least one uplink power control parameter set.

14. The method according to claim 9, wherein the network device is an interfered network device, the terminal is an interfered terminal served by the network device; the method further comprising:
performing an interference measurement on a downlink signal of an interfering network device at a predetermined time-frequency position; and
determining the interference degree of the at least one resource set based on the interference measurement.

15. The method according to claim 9, wherein the network device is an interfering network device, and the terminal is an interfering terminal served by the network device; the method further comprising:
receiving the interference degree of the at least one resource set sent by an interfered terminal, wherein the interfered terminal is a terminal interfered by the interfering terminal; or
receiving the interference degree of the at least one resource set sent by a network device serving the interfered terminal,
wherein the interference degree of the at least one resource set is obtained by the interfered terminal performing an interference measurement on an uplink signal of the interfering terminal at a predetermined time-frequency position.

16.-17. (canceled)

18. A terminal, comprising a processor and a memory, wherein the memory stores a computer program, and when the computer program is executed by the processor, the terminal is configured to:
receive first configuration information sent by a network device;
determine at least one uplink power control parameter set;
select an uplink power control parameter set corresponding to a target transmission resource set from the at least one uplink power control parameter set; and
perform uplink power adjustment on the target transmission resource set.

19. A network device, comprising a processor and a memory, wherein the memory stores a computer program, and when the computer program is executed by the processor, the processor is configured to perform the method according to claim 9.

20. A non-transitory computer-readable storage medium, configured to store instructions, wherein when the instructions are executed, the method according to claim 1 is implemented.

21. A non-transitory computer-readable storage medium, configured to store instructions, wherein when the instructions are executed, the method according to claim 9 is implemented.
